(19) United States
(12) Patent Application Publication
(10) Pub. No.: US 2015/0311658 A1
(43) Pub. Date: Oct. 29, 2015

(54) SOCKET SYSTEM

(71) Applicant: Daniel L. Zamarron, Henderson, NV (US)

(72) Inventor: Daniel L. Zamarron, Henderson, NV (US)

(21) Appl. No.: 14/260,193

(22) Filed: Apr. 23, 2014

(51) Int. Cl. H01R 39/64; H01R 24/78

(52) U.S. Cl. CPC H01R 39/64; H01R 24/78; H01R 2103/00

(57) ABSTRACT

A socket adapter system freely rotates, twists, and turns up to 360° to inhibit undesirable tangling and detachment by an attached cord, due to the latitude of movement provided thereto. Pressure exerted from the attaching external plug actuates the socket adapter system to rotate, as a space is created between internal bearings. A master housing protects the system and engages a mounted socket. A plug housing carries electrical current to the mounted socket with inner and outer conductors that terminate at prongs. Inner channels in the plug housing carry bearings. A brace portion holds the plug housing stationary against the master housing. A rotating socket receives an external plug and rotatably joins with the plug housing and includes outer channels that align with the inner channels of the plug housing for containing the bearings, which reduce friction to enable free rotation.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a socket system. More particularly, the invention relates to a socket adapter that rotates to inhibit undesirable tangling and detachment by an attached cord.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that A/C power plugs and sockets are electrical reception points that allow electrical devices to be connected to the primary alternating current power supply in a building. The electrical plugs and sockets differ in voltage and current rating, shape, size and type of connectors.

Typically, the plug is the movable connector attached to an electrically operated device's mains cable, and the socket is fixed on equipment or a building structure and connected to an energized electrical circuit. Often, the plug has protruding prongs, blades, or pins that fit into matching slots or holes in the sockets. Sockets are designed to prevent exposure of bare energized contacts. Sockets may also have protruding exposed contacts, but these are used exclusively for grounding.

In many instances, electrical home appliances, such as refrigerator, washing machine, television, electric fan, electric hair dryers, connect to the socket, or electric outlet to obtain the necessary working voltage. Regular electric outlets include fixed type fixedly installed in the wall, and movable type equipped with an electric extension cable. Often, the cords for these electrical devices detach or tangle because there is insufficient play and latitude during operation.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate detailed perspective views of exemplary mounted sockets working with and without an exemplary socket adapter system, where FIG. 1A illustrates an exemplary tangled cord joined with an exemplary mounted socket, and FIG. 1B illustrates an exemplary cord rotated into a straight configuration and joined with the socket adapter system, in accordance with an embodiment of the present invention;

FIGS. 2A and 2B illustrate detailed perspective views of an exemplary socket adapter system, where FIG. 2A illustrates a front view with an exemplary rotating socket rotating 360°, and FIG. 2B illustrates a rear view of an exemplary at least one prong extending from the master housing, in accordance with an embodiment of the present invention;

FIGS. 3A and 3B illustrate expanded views of an exemplary socket adapter system, where FIG. 3A illustrates a front angle view, and FIG. 3B illustrates a rear angle view, in accordance with an embodiment of the present invention;

FIG. 4 illustrates a sectioned top view of an exemplary plug housing, in accordance with an embodiment of the present invention; and

FIGS. 5A and 5B illustrate detailed perspective views of an exemplary socket adapter system with a plurality of rotating sockets sharing the same master housing, where FIG. 5A illustrates a front view with two exemplary rotating sockets, and FIG. 5B illustrates a rear view with two sets of prong extending therefrom, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of socket adapter systems that may be provided by preferred embodiments of the present invention. In one embodiment of the present invention, the socket adapter system may freely rotate, twist, and turn up to 360° to inhibit undesirable tangling and detachment by an attached cord. The rotational movement of the system may help inhibit tangling and detachment by an attached cord, due to the latitude of movement provided thereto. Specifically, the socket adapter system may include an electronic adapter plug with a freely rotating socket that can be inserted into a standard alternating current mounted socket. In this manner, an external electrical plug may join with the socket adapter for enabling free rotation thereof. Some embodiments may be modified for use with nonelectrical transmissions such as, but not limited to, fluids and connecting hoses.

It is significant to note that the pressure exerted from the attaching external plug is what actuates the socket adapter system to rotate. As a standalone with no inserted external plug, the socket adapter system may not rotate. The rotational capacity of the socket adapter system may enable the cord to detangle and adjust out of complex configurations. Those skilled in the art, in light of the present teachings, will recognize that a tangled cord may cause cord damage, delay work as the cord has to be untangled, make an area appear unkempt, and cause the cord to detach from the socket. These cord complications may be overcome by enabling the socket adapter system to rotate and create free movement.

In some embodiments, the system may include a master housing that forms a protective cover over the components of the system. The master housing may engage a mounted socket, such as an alternating current socket in a wall. The master housing may include at least one aperture for enabling passage of connectors and plugs to join with the mounted socket.

The system may further include a plug housing that serves as a rotating conduit, conducting electrical current from the external plug, to the mounted socket. The plug housing may include a plug end that is proximal to the mounted socket. The plug end may include at least one prong for mating with the mounted socket. The at least one prong may include prongs that match the mounted socket configuration, including, without limitation, a ground plug and two blades.

An inner surface on the plug end may include a first inner channel configured to carry at least one first bearing. The at least one first bearing may help constrain relative motion of the plug housing and reduce friction between moving parts to facilitate the rotational movement of the system. In some embodiments, the plug housing may further include a socket end that is proximal to the external plug. The inner surface of the socket end may host a second inner channel that serves substantially the same job as the first inner channel, carrying the at least one second bearing for facilitating rotation along with the first bearing.

In some embodiments, the inner surface may include at least one inner conductor that conducts the electrical current from to the at least one prong. In one embodiment, three inner conductors, each correlating to a separate prong, may transmit current accordingly. At least one insulator segregates each inner conductor, such that the appropriate current reaches each prong.

In some embodiments, the plug housing may include an outer surface. The outer surface may include at least one outer conductor that is a continuation of the at least one inner conductor. The at least one outer conductor may join with the at least one prong. In this manner, the electrical current passes from the at least one inner conductor, to the at least one outer conductor, before finally terminating at the at least one prong, which mates with the mounted socket.

In some embodiments, the outer surface of the plug housing may further include a brace portion for helping to retain the plug housing immobile in relation to other rotating components of the system. The brace portion may include four stabilizing wings that extend from the outer surface to a master housing inner surface. In this configuration, the brace portion may form a brace that retains the plug housing in a relatively stationary position to other components of the system.

In some embodiments, the system may include a rotating socket that rotatably joins with the plug housing. The rotating socket may rotate in relation to the stationary plug housing and the master housing. The rotating socket may include a rotating socket end that is distal to the external plug. The rotating socket end may include at least one aperture for receiving the external plug. The at least one aperture may match the configuration of the external plug.

The rotating socket end may further include a first exterior channel that aligns with the first inner channel on the plug housing. The at least one first bearing may position in the space between the channels, facilitating rotation of the rotating socket in relation to the immobile plug housing. Similarly, a rotating plug end on the rotating socket may include a second exterior channel that aligns with the second inner channel, and retains the at least one second bearing in between for facilitating the rotating motion of the rotating socket. The first and second bearings work together to facilitate rotation.

In some embodiments, the rotating socket comprises an external rotating socket surface that enables passage of at least one conductive member from engagement with the external plug, to engagement with the at least one inner conductor in the plug housing. In this manner, the electrical current may pass through the rotating socket, and then the plug housing, before transmitting through the mounted socket.

This transmission of currency may occur while the rotating socket rotates, swivels, and twist. In one embodiment, the rotating socket rotates only upon engagement and pressure applied by the external plug. In another embodiment, the rotating socket only rotates in a segment of the 360° rotation, such as half a turn. In any case, the at least one bearing enables a free, unrestricted rotation without the risk of the attached cord becoming detached or tangled.

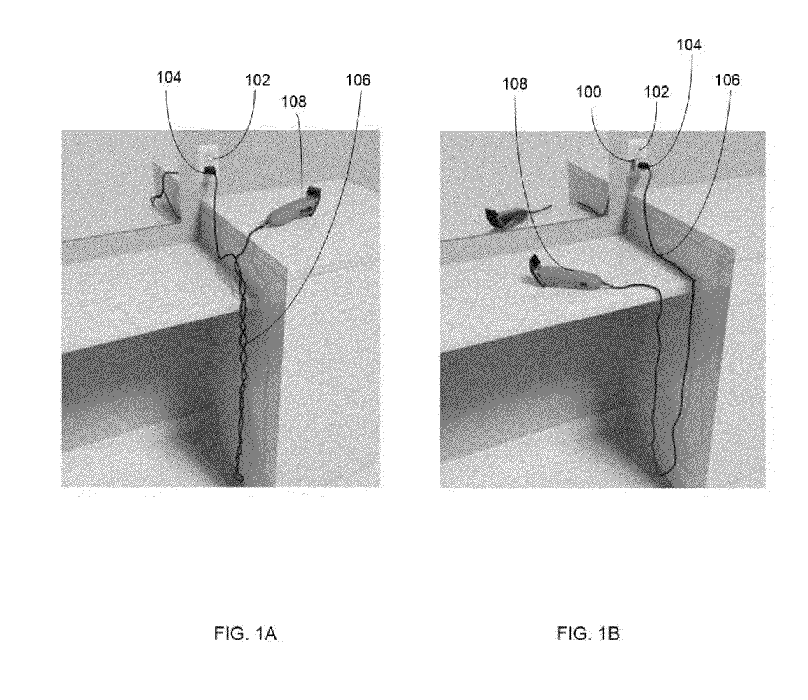

FIGS. 1A and 1B illustrate detailed perspective views of exemplary mounted sockets working with and without an exemplary socket adapter system, where FIG. 1A illustrates an exemplary tangled cord joined with an exemplary mounted socket, and FIG. 1B illustrates an exemplary cord rotated into a straight configuration and joined with the socket adapter system, in accordance with an embodiment of the present invention. In the present invention, a socket adapter system 100 may freely rotate, twist, and turn up to 360° to inhibit undesirable tangling and detachment by an attached cord. The system may also rotate a portion of the 360° arc, such as a half or quarter turn. In any case, the rotational movement of the system may help inhibit tangling and detachment by an attached cord 106, due to the latitude of movement provided thereto. Stress and tension on the cord may also be inhibited.

Specifically, the socket adapter system may include an electronic adapter plug with a freely rotating socket that can be inserted into a standard alternating current mounted socket 102. In this manner, an external plug 104 may join with the socket adapter for enabling free rotation thereof, and inhibiting tangling, detachment, and other undesirable configurations of the cord. For example, without limitation, as the cord of an electrical device 108 is plugged into the system and the electrical device is moved, the external plug may swivel, twist back and forth, and even spin completely around in an effort to keep the cord untangled. In some embodiments the system may be configured to enable the plug to swivel, turn, rotate, or gyrate back and forth, up and down, left and right, etc.

Suitable materials for the system may include, without limitation, melamine formaldehyde, polyester resin, polycarbonate, a thermo polymer, polyvinyl chloride, and a rigid polymer. Additionally, the system may accommodate any type of socket configuration designated for use in the United States by the National Electrical Manufacturers Association, such as NEMA 1-15 and 5-15. The system may also be made in variations intended for use in other countries, and feature socket configurations designated for their use, including, without limitation, Types E, F, E/F hybrid, G, H, I, J, K, L and M; CEE 7/16; and BS 546. The system may also comprise both polarized and non-polarized formats.

In yet another embodiment, the system may be fabricated in variations of a socket adapter for attachment to a central processing unit plug, and with purpose of affording its convenience to a computer, computer-attachable components, and other personal electronics. The system may be produced in various colors, and may or may not bear various images and/or logos, which may or may not be of registered trademark and/or copyright status.

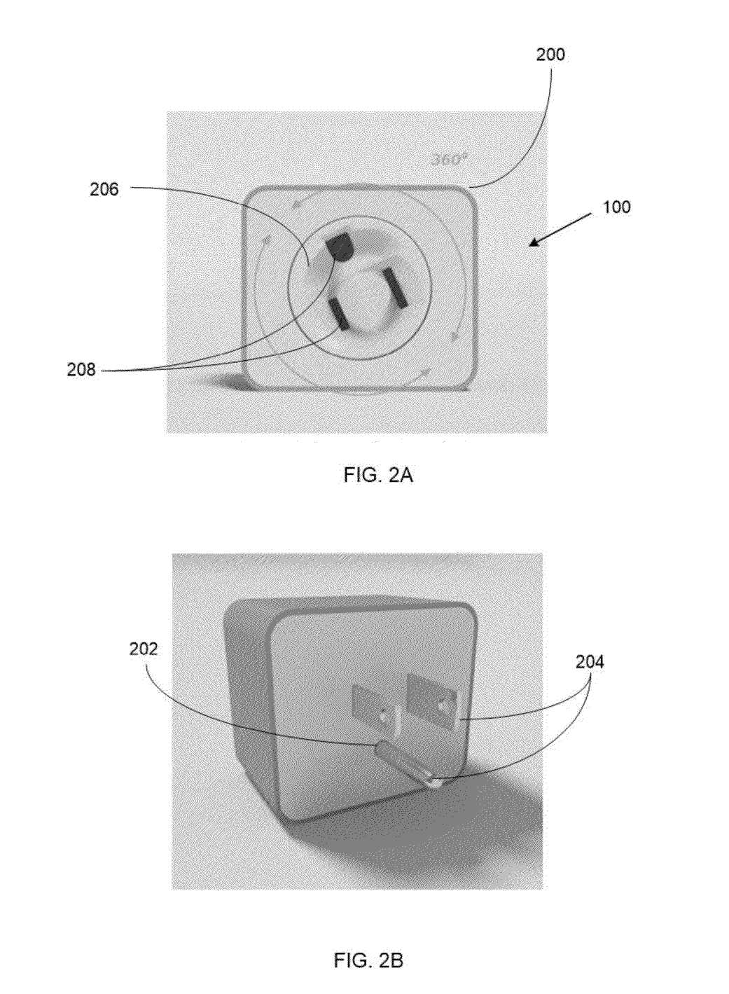

FIGS. 2A and 2B illustrate detailed perspective views of an exemplary socket adapter system, where FIG. 2A illustrates a front view with an exemplary rotating socket rotating 360°, and FIG. 2B illustrates a rear view of an exemplary at least one prong extending from the master housing, in accordance with an embodiment of the present invention. In the present invention, the system may rotate, twist, or swivel when the external plug engages, and applies a pressure. In this manner, the system remains stationary until a need arises to rotate.

It is significant to note that the pressure exerted from the attaching external plug is what actuates the socket adapter system to rotate as the spinning socket of the device easily moves when pressure is applied to the socket. Therefore, when a cord is swinging, moving back and forth, or being twisted, the pressure upon the cord created by this movement of the cord is transferred to the device and typically causes the spinning socket to move in the same manner as the cord. As a standalone with no inserted external plug, the socket adapter system may not rotate. The pressure from the attached external plug releases the system for rotation by creating extra space in an internal bearing configuration. The extra space enables the bearings to rotate more freely, thus enabling rotation. In one embodiment, the master housing may include a substantially cube shape. The master housing may include a round opening on a front wall. The at least one housing aperture may be arranged on a back wall. The housing apertures may include a shape and placement to accept insertion of prongs.

The rotational capacity of the socket adapter system may enable the cord to detangle and adjust out of complex configurations. Those skilled in the art, in light of the present teachings, will recognize that a tangled cord may cause cord damage, delay work as the cord has to be untangled, make an area appear unkempt, and cause the cord to detach from the socket. These cord complications may be overcome by enabling the socket adapter system to rotate and create free movement.

In some embodiments, the system may include a master housing 200 that forms a protective cover over the components of the system. The master housing may engage a mounted socket, such as an alternating current socket in a wall. The master housing may include at least one housing aperture 202 for enabling passage of at least one prong 204, such as connectors and plugs from the components of the system to join with the mounted socket.

In some embodiments, a rotating socket receives an electrical current from the external plug at a rotating socket end 206. At least one aperture 208 may enable at least partial passage of the external plug through the rotating socket end for conducting the electrical current. The electrical current may travel through the system, until passing to the mounted socket. The system may remain rotational, even while conducting the electrical current. In this manner, an electrical device may operate, while the cord from the electrical device remains tangle free.

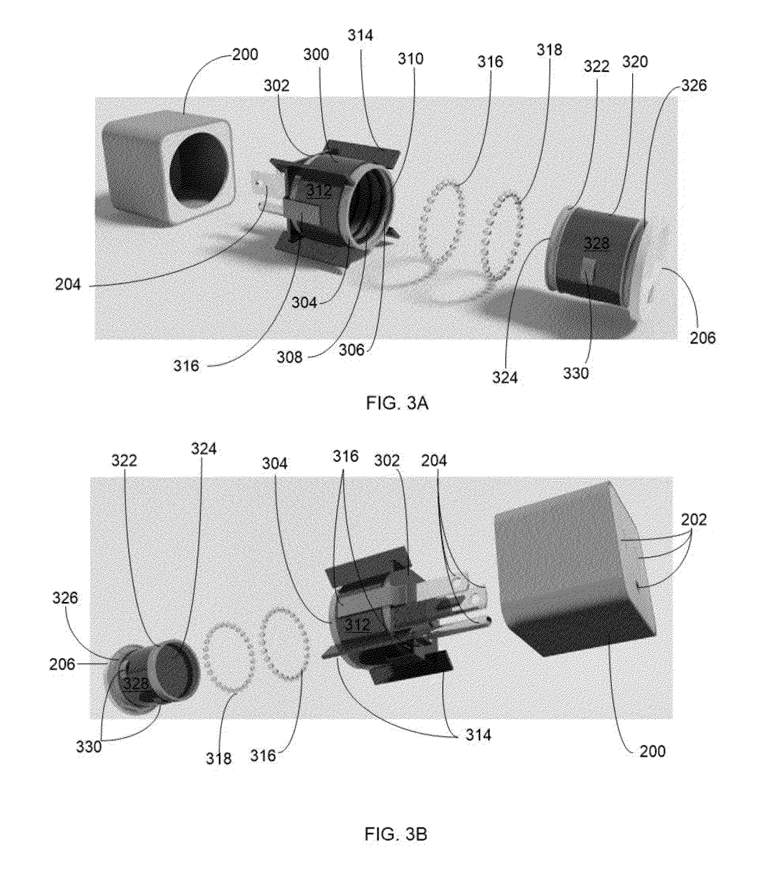

FIGS. 3A and 3B illustrate blow up views of an exemplary socket adapter system, where FIG. 3A illustrates a front angle view, and FIG. 3B illustrates a rear angle view, in accordance with an embodiment of the present invention. In the present invention, the system may further include a plug housing 300 that serves as a rotating conduit, conducting electrical current from the external plug, to the mounted socket. The plug housing may include a plug end 302 that is proximal to the mounted socket. The plug end may include the at least one prong for mating with the mounted socket, and thereby conducting the electrical current. The at least one prong may include prongs that match the mounted socket configuration, including, without limitation, a ground plug and two blades. However, in other embodiments, any combination of prong sizes and shapes may be utilized, depending on the electrical specifications. In one embodiment, the at least one prong may include a stainless steel composition, and display in an NEMA 5-15 pattern.

An inner surface on the plug end may include a first inner channel configured to carry at least one first bearing 316. The at least one first bearing may help constrain relative motion of the plug housing and reduce friction between moving parts to facilitate the rotational movement of the system. In some embodiments, the plug housing may further include a socket end 304 that is proximal to the external plug. The inner surface of the socket end may host a second inner channel 306 that serves substantially the same job as the first inner channel, carrying at least one second bearing for facilitating rotation along with the first bearing. It is contemplated that various different types of bearings may be used in dome embodiments such as, but not limited to, ball bearings, sleeve bearings, roller bearings, angular contact bearings, etc.

In some embodiments, the inner surface may include at least one inner conductor 308 that conducts the electrical current from to the at least one prong. In one embodiment, three inner conductors, each correlating to a separate prong, may transmit current accordingly. At least one insulator 310 segregates each inner conductor, such that the appropriate current reaches each prong. Suitable materials for the at least one inner conductor may include, without limitation, copper, stainless steel, brass and iron, and copper or brass coated materials.

In some embodiments, the plug housing may include an outer surface 312. The outer surface may include at least one outer conductor 316 that is a continuation of the at least one inner conductor. The at least one outer conductor may join with the at least one prong. In this manner, the electrical current passes from the at least one inner conductor, to the at least one outer conductor, before finally terminating at the at least one prong, which mates with the mounted socket. Suitable materials for the at least one outer conductor may include, without limitation, copper, stainless steel, brass and iron, and copper or brass coated materials.

In one example of the conduction of electrical current through the plug housing, the at least one inner conductor may include three copper strips that make contact with three correlating outer conductor copper rings. The outer rings run along the outer surface of the plug housing at 90°, 180°, and 270° arc-points. The outer strips at the 90° and 270° points attach to plug blades that project from the plug end. The outer strip at the 180° point attaches to a grounding plug. In some embodiments the placement of the conducting strips may vary to be positioned at any points along the circumferential body of the device. For example, without limitation, the conducting strips may be on the same side with small distances between them, etc.

In some embodiments, the outer surface of the plug housing may further include a brace portion 314 for helping to retain the plug housing immobile in relation to other rotating components of the system. The brace portion may include four stabilizing wings that extend from the outer surface to a master housing inner surface. In this configuration, the brace portion may form a brace that retains the plug housing in a relatively stationary position to other components of the system.

In some embodiments, the system may include a rotating socket 320 that rotatably joins with the plug housing. The rotating socket may rotate in relation to the stationary plug housing and the master housing. The rotating socket may include a rotating socket end 324 that is distal to the external plug. The rotating socket end may include at least one aperture for receiving the external plug. The at least one aperture may match the configuration of the external plug.

In some embodiments, the rotating socket end may further include a first exterior channel 322 that aligns with the first inner channel on the plug housing. The at least one first bearing may position in the space between the channels, facilitating rotation of the rotating socket in relation to the immobile plug housing. Similarly, a rotating plug end on the rotating socket may include a second exterior channel 326 that aligns with the second inner channel, and retains the at least one second bearing in between for facilitating the rotating motion of the rotating socket.

In some embodiments, the rotating socket comprises an external rotating socket surface 328 that enables passage of at least one conductive member 330 from engagement with the external plug, to engagement with the at least one inner conductor in the plug housing. In this manner, the electrical current may pass through the rotating socket, and then the plug housing, before transmitting through the mounted socket.

This transmission of currency may occur while the rotating socket rotates, swivels, and twist. In one embodiment, the rotating socket rotates only upon engagement and pressure applied by the external plug. In another embodiment, the rotating socket only rotates in a segment of the 360° rotation, such as half a turn. In any case, the at least one bearing enables a free, unrestricted rotation without the risk of the attached cord becoming detached or tangled.

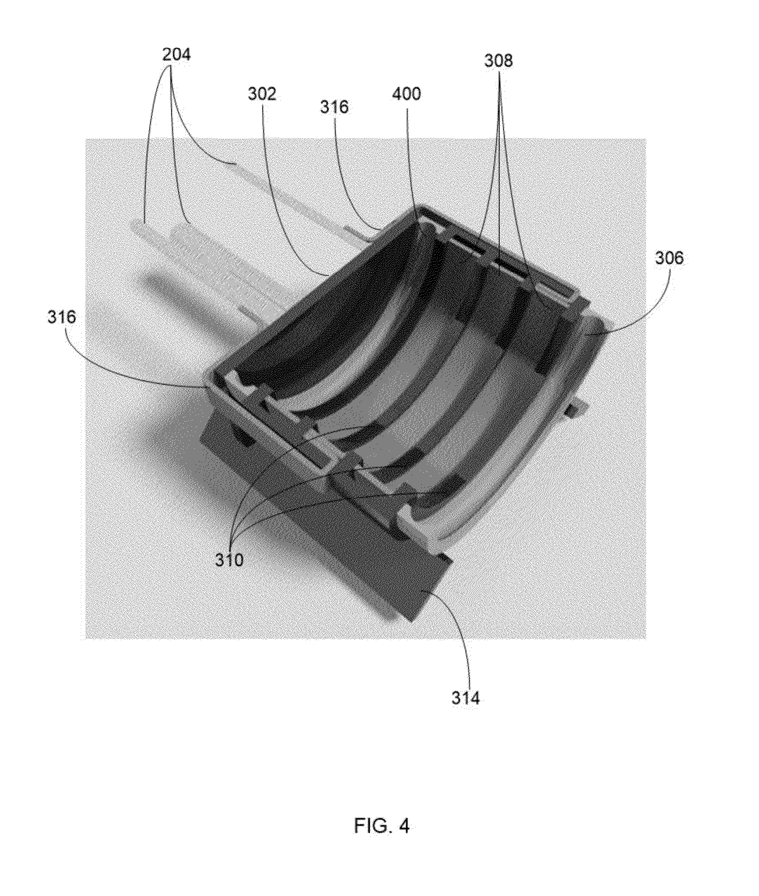

FIG. 4 illustrates a sectioned top view of an exemplary plug housing, in accordance with an embodiment of the present invention. In the present invention, the inner surface on the plug housing may include a first inner channel 400 configured to carry the at least one first bearing. The inner surface may host a second inner channel that serves substantially the same job as the first inner channel, carrying at least one second bearing for facilitating rotation along with the first bearing. The first and second bearings work together to facilitate rotation. In other embodiments, additional channels and bearings may be utilized, and more bearings may make the housing easier to spin.

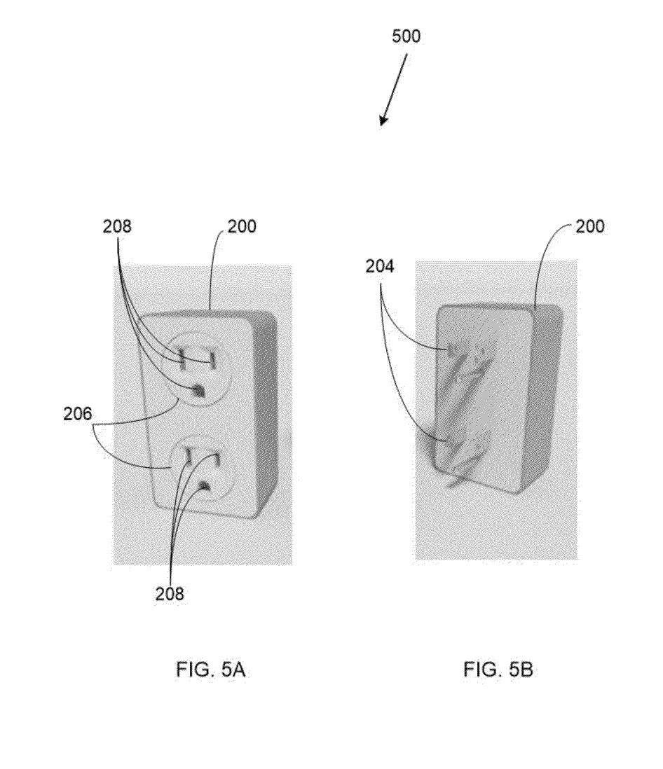

FIGS. 5A and 5B illustrate detailed perspective views of an exemplary socket adapter system with a plurality of rotating sockets sharing the same master housing, where FIG. 5A illustrates a front view with two exemplary rotating sockets, and FIG. 5B illustrates a rear view with two sets of prong extending therefrom, in accordance with an embodiment of the present invention. In the present invention, the master housing protects the plug housing and the rotating socket from physical damage and external elements. The master housing mat include a plurality of rotating sockets system 500. The plurality of sockets may include two or more. The plurality of rotating sockets system may operate in substantially the same manner as a single rotating socket in the master housing. In one embodiment, the plurality of rotating sockets system may include a power strip, in which the individual rotating sockets are rotatable within the master housing of the strip.

In one alternative embodiment, the system forms an adapter for use in plumbing, whereby the socket receives a water hose. In yet another alternative embodiment, the system is adaptable to work with direct currents. In yet another alternative embodiment, the adapter plug can extend and retract from the master housing, in addition to twisting.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a rotating adapter plug according to the present invention will be apparent to those skilled in the art. Various aspects of the invention have been described above by way of illustration, and the specific embodiments disclosed are not intended to limit the invention to the particular forms disclosed. The particular implementation of the rotating adapter plug may vary depending upon the particular context or application. By way of example, and not limitation, the rotating adapter plug described in the foregoing were principally directed to an adapter plug that inserts into an AC power socket and receives an external plug, while enabling rotation of the attached cord from the external plug implementations; however, similar techniques may instead be applied to plumbing connections, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a master housing configured to at least partially contain said system, said master housing further configured to engage a mounted socket, said master housing comprising at least one housing aperture;
a plug housing configured to at least partially conduct an electrical current to said mounted housing, said plug housing comprising a plug end, said plug end comprising at least one prong disposed to at least partially pass through said at least one housing aperture, said at least one prong configured to engage said mounted socket, said plug end further comprising a first inner channel configured to carry at least one first bearing, said plug housing further comprising an inner surface, said inner surface comprising at least one inner conductor, each inner conductor configured to carry said electrical current to a corresponding prong, said plug housing further comprising an outer surface, said outer surface comprising a brace portion disposed to extend from said outer surface to an inner master housing surface, said brace portion configured to at least partially restrict rotation of said plug housing; and
a rotating socket configured to rotatably restrict entanglement and detachment of a cord joined to an external plug, said rotating socket disposed to rotatably join with said plug housing for transmitting said electrical current while said rotating socket rotates and said plug housing remains immobile, said rotating socket comprising a rotating socket end, said rotating socket end comprising at least one aperture configured to at least partially receive said external plug, wherein engaging said rotating socket end with pressure from said external plug actuates said rotation, said rotating socket end further comprising a first exterior channel arranged to align with said first inner channel, wherein said at least one first bearing is configured to position between said first exterior channel and said first inner channel, said at least one first bearing further configured to constrain relative motion and reduce friction between said rotating socket and said plug housing for facilitating rotation of said rotating socket.

2. The system of claim 1, in which said mounted socket comprises an alternating current socket.

3. The system of claim 2, in which said at least one prong comprises a ground plug and two blades.

4. The system of claim 3, in which said cord joins with a hand held electrical device.

5. The system of claim 4, in which said at least one first bearing comprises a first ring of ball bearings, said at least one second bearing comprising a second ring of ball bearings.

6. The system of claim 5, in which said master housing contains a plurality of rotating sockets and a plurality of plug housings.

7. The system of claim 6, in which said plug housing comprises a socket end, said socket end comprising a second inner channel configured to carry at least one second bearing.

8. The system of claim 7, in which said plug housing comprises at least one external conductor configured to conduct said electrical current from said at least one inner conductor to said at least one prong.

9. The system of claim 8, in which said inner surface of said plug housing comprises at least one insulator disposed to position between each inner conductor.

10. The system of claim 9, in which said at least one insulator segregates said electrical current on said at least one inner conductor.

11. The system of claim 10, in which said at least one inner conductor comprises three conductor strips in staggered alignment for matching a depth of three external conductors of the plug housing.

12. The system of claim 11, in which said brace portion comprises four stabilizing wings.

13. The system of claim 12, in which said rotation of said rotating socket comprises a rotation of up to 360 degrees.

14. The system of claim 13, in which said rotating socket comprises a rotating plug end, said rotating plug end comprising a second exterior channel arranged to align with said second inner channel, wherein said at least one second bearing is configured to position between said second exterior channel and said second inner channel, said at least one second bearing further configured to constrain relative motion and reduce friction between said rotating socket and said plug housing for facilitating rotation of said rotating socket.

15. The system of claim 14, in which said rotating socket comprises an external rotating socket surface, said external rotating rocket surface comprising at least one conductive member configured to conduct said electrical current from said external plug to said at least one inner conductor.

16. The system of claim 15, in which said at least one conductive member comprises a copper tab.

17. The system of claim 16, in which said system comprises a melamine formaldehyde composition.

18. The system of claim 17, in which said system is configured to conform to a socket configuration designated for use in the United States by the National Electrical Manufacturers Association, said socket configuration comprising NEMA 1-15 and/or NEMA 5-15.

19. A system comprising:
means for joining an external plug with a rotating socket;
means for carrying an electrical current from said rotating socket to a mounted socket through a plug housing;
means for rotating said rotating socket;
means for restricting rotation of said plug housing with a brace portion; and
means for at least partially inhibiting tangling and detachment of a cord joined with said external plug.

20. A system consisting of:
a master housing configured to at least partially contain said system, said master housing further configured to engage a mounted socket, said master housing comprising at least one housing aperture, said at least one housing aperture comprising three apertures;
a plug housing configured to at least partially conduct an electrical current to said mounted housing,
said plug housing comprising a plug end, said plug end comprising at least one prong disposed to at least partially pass through said at least one housing aperture, said at least one prong comprising a ground plug and two blades, said at least one prong configured to engage said mounted socket, said mounted socket comprising an alternating current socket,
said plug end further comprising a first inner channel configured to carry at least one first bearing, said at least one first bearing comprising a first ring of ball bearings,
said plug housing further comprising a socket end, said socket end comprising a second inner channel configured to carry at least one second bearing,
said plug housing further comprising an inner surface, said inner surface comprising at least one inner conductor, each inner conductor configured to carry said electrical current to a corresponding prong, said at least one inner conductor comprising
said plug housing further comprising an outer surface, said outer surface comprising a brace portion disposed to extend from said outer surface to an inner master housing surface, said brace portion configured to at least partially restrict rotation of said plug housing, said brace portion comprising four stabilizing wings; and
a rotating socket configured to rotatably restrict entanglement and detachment of a cord joined to an external plug, said rotating socket disposed to rotatably join with said plug housing for transmitting said electrical current while said rotating socket rotates and said plug housing remains immobile,
said rotating socket comprising a rotating socket end, said rotating socket end comprising at least one aperture configured to at least partially receive said external plug, wherein engaging said rotating socket end with pressure from said external plug actuates said rotation,
said rotating socket further comprising an external rotating socket surface, said external rotating rocket surface comprising at least one conductive member configured to conduct said electrical current from said external plug to said at least one inner conductor, said at least one conductive member comprising a copper tab,
said rotating socket end further comprising a first exterior channel arranged to align with said first inner channel, wherein said at least one first bearing is configured to position between said first exterior channel and said first inner channel, said at least one first bearing further configured to constrain relative motion and reduce friction between said rotating socket and said plug housing for facilitating rotation of said rotating socket,
said rotating socket further comprising a rotating plug end, said rotating plug end comprising a second exterior channel arranged to align with said second inner channel, wherein said at least one second bearing is configured to position between said second exterior channel and said second inner channel, said at least one second bearing further configured to constrain relative motion and reduce friction between said rotating socket and said plug housing for facilitating rotation of said rotating socket.
